(19) United States
(12) Patent Application Publication
(10) Pub. No.: US 2003/0171974 A1
(43) Pub. Date: Sep. 11, 2003

(54) Recalled products business method

(76) Inventor: Dana B. Taschner, Los Angeles, CA (US)

Correspondence Address: SANFORD ASTOR, SUITE 200, 10507 WEST PICO BLVD, LOS ANGELES, CA, 90064, US

(21) Appl. No.: 09/881,895

(22) Filed: Jun. 15, 2001

(51) Int. Cl. G06F 17/60

(52) U.S. Cl. 705/10

(57) ABSTRACT

An Internet web site portal and a business method for attorneys, who engage in handling product liability cases, to obtain cases from consumers who have been injured by recalled, dangerous or defective products comprising, creating an Internet web site specifically for recalled, dangerous or defective products, said site comprising information, analysis, resources and materials, including links to government agencies and resources, manufacturers, health and medical organizations, claim or settlement programs and product liability attorneys, to provide to the consumer, comprehensive information and resources on recalled, dangerous or defective products, creating specific sub-sites for each catagory of product and second sub-sites for each specific recalled, dangerous or defective product within each catagory, each said site, link and sub-site having a link to enable the consumer to contact an attorney (law firm), in the consumer's geographical area, who engages in handling product liability cases, means for the consumer to contact an attorney electronically, by e-mail or by completion of an electronic questionnaire specific to recalled, dangerous or defective products.

### BACKGROUND OF THE INVENTION

Each year, over 1000 products are recalled, with over 100,000 deaths attributed to recalled or dangerous products. Numerous governmental agencies, such as the Food and Drug Administration, the Consumer Product Safety Commission and the National Highway Safety Administration recall products or issue safety alerts or warnings. In addition to government recalls, manufacturers voluntarily withdraw products.

Many recalls, safety alerts or withdrawals occur following reports of serious injury or death related to a specific product or drug. In the event of a product recall, many people including consumers, health professionals, pharmacists, retailers, business owners, legal professionals, employers, and others, look for information about the recall. Information about recalls is incredibly chaotic and decentralized, with various entities, including the government, manufacturers, retailers, consumer groups and trial lawyers, all disseminating various forms of information for various reasons or purposes, many of which are to decrease consumer concern (manufacturers and retailers) or increase consumer concern and awareness (trial lawyers), all with significant economic incentives to the success of their view. Consumers, in he event they feel that they have been injured by a recalled or dangerous product, are looking for a “one-stop” location where they can seek comprehensive information about products, health, medicine, claims and law, and thereby be empowered to determine potential health or medical hazards, and to seek qualified legal representation or to file a claim, including recalls resulting in establishment of a national claim center.

When a substantial number of consumers have used a particular product that is recalled or withdrawn from the market, complex government action and/or national litigation often follows, with complicated proceedings that may be coordinated or consolidated, resulting in national administration of the legal process and claims administration. Of the over four hundred thousand lawyers nationally, fewer than 1000 specialize in the complicated field of multidistrict or national litigation involving recalled or dangerous products. Against the extreme difficulty in locating a lawyer specialized in this field, is the recognition that most consumers have never hired a lawyer and are unfamiliar with the legal process, not knowing where to locate a lawyer or how to seek appropriate representation in the complicated field of national product liability law. Additionally, government agencies, health organizations, health professionals and manufacturers frequently seek to distribute current information about the reason for the recall or withdrawal and to describe the side effects, diseases, injuries or problems which consumers may experience as a result of the recalled or faulty product. Examples of national product recalls include Silicone Gel Breast Implants, Fen Phen Diet Drugs, Firestone/Bridgestone Tires, Baby Carrier/Car Seats and Sulzer Hip Implant Devices.

In each of these instances of product recalls, consumers, health professionals or even regional lawyers may be confused and without the ability to access coordinated information about the recall or safety alert, about governmental information or determinations concerning a product, about health information, about manufacturer information and recommendations (refunds and health recommendations), medical news and information, and legal or claim information about preserving legal rights and participating in national claims programs.

The recent proliferation of the Internet has led consumers to the web in search of information when they or a family members have purchased, used, or been injured by a recalled or faulty product, particularly when the recalled or faulty product is a drug or medical device. The Atlanta Journal-Constitution reported on Apr. 22, 2001 that 98 million adults “regularly look for health information on the Internet.” Although each is searching for help only for himself or for someone close to him, collectively they are reshaping U.S. health care. The Internet allows consumers to access information about medicine, health news, law, products, government activity and regulation and related topics, but nowhere on the Internet or anywhere else does any singular source deliver the collective information needed by a consumer in the event of a product or drug recall.

Although the Internet has only been available for broad use in very recent years, six out of every ten Americans now have ready access to it, a proportion that is expected to grow to nine out of ten by 2010. “Half of those who have online access look for health information at least once a month”, according to the Pew Internet and American Life Center. Importantly, two out of every five say their research affects decisions they make about which professionals to contact. “The influence of the Internet, and the knowledgeable consumers it creates, is so powerful that national health authorities envision it as the spine of the reorganized medical system.” Atlanta Journal-Constitution (Apr. 22, 2001).

According to the Institute of Medicine, which advises Congress on health policy, “The Internet is rapidly transforming many aspects of society and many health-related processes stand to be reshaped as well.” Among the most significant “health-related” processes to be reshaped is the legal services sector, which services consumers and patients. Regena Shell, a recovering cancer patient living in a rural Georgia, quoted by the Atlanta Journal, said it plainly, “when it applies to your health, knowledge is your most powerful weapon” and “everyone in America ought to have access to this.”

Product liability litigation has become one of the most lucrative segments of the legal field, with legal fees in various product liability cases exceeding one billion dollars. Examples of such cases include tobacco product liability claims, Fen Phen diet drug product liability claims and asbestos product liability claims.

The product liability business traditionally has required high cost/low yield advertising. To attract and secure cases, lawyers and law firms spend vasts amounts of money advertising for claims and then manually collecting inquiries and manually reviewing the claims. For example, one firm of the many firms nationally involved in asbestos product liability claims, spends approximately six million each year to advertise for asbestos clients. The majority of the advertising is in print or television advertising. The advertising lists the services provided and provides the television viewer or print reader with a telephone number. The interested or injured party telephones the law offices advertising the services. The telephone call triggers the need to have a receptionist field the telephone call. The receptionist determines the nature of the call, and routes the caller to the appropriate person (lawyer, paralegal, assistant or secretary) to manually interview the caller by phone, to determine whether a potential case exists. Often times the caller cannot provide adequate information and a subsequent appointment is established for a face-to-face meeting at the lawyer's office. The prospective client hen physically travels to the lawyer's office and meets with the lawyer or representative of his office (or the lawyer or the representative travels to the prospective client's home, office or another location) to determine whether a potential case exists. If so, a contract between the lawyer and the client is executed and the advertising has resulted in the lawyer's engagement by the client.

### SUMMARY OF THE INVENTION

The Business Method of the present invention significantly reduces advertising costs with (1) far superior market penetration, and (2) greatly expanded shelf life for advertising. The Business Method removes most of the above described steps, significantly reduces costs to effect engagement, and streamlines time and procedures for reviewing potential cases or claimants. For example, a print, TV or radio spot or advertisement is typically a one-time purchase for one day or a group of days (in the case of newspaper advertising) or 30-60 seconds (if a radio or TV ad). These ads have limited regional reach, broadcasting (or circulating) in a limited geographic area, typically representing a very small percentage of the potential national market. This Business Method does two things traditionally advertising cannot, in terms of penetration, 1) the Business Method harnesses the Internet to reach all of North America, as well as the globe, and 2) the Business Method is not a one day or 30/60 second one-time commercial purchase, but exists 7 days a week, 24 hours a day, and is not contingent upon a consumer/customer viewing the TV, hearing the radio, or reading a specific newspaper on a particular day, or at a particular hour (TV and radio).

This Business Method immediately provides the consumer with a far superior and standardized service and product. In addition to these new market penetration features the Business Method provides he consumer/customer with a far superior product and advertising appeal, with broader and more comprehensive information and service by offering in-depth information and reports about products, recall or safety information, claims and consumer claim registration forms, legal proceedings, medical information, doctor views, government reports, and news. Additionally the consumer/customer (and the operator of the business method) is not (1) reliant upon the skill, training, behavior or attentiveness of a receptionist, operator, secretary or other representative and (2) is not limited to regular business hours in a specific time zone, but provides comprehensive information and service 7 days a week, 24 hours a day, 365 days each year, without the accompanying salaries, benefits and other costs required for maintenance and employment of employees housed in offices, requiring additional capitalization. Operating expensive phone systems and networks requires additional capitalization, all of which provide far less service for significantly fewer hours each week, at a significantly increased cost and capitalization.

This Business Method immediately and electronically analyzes consumers claims by providing a questionnaire to be filled out online. Whereas traditional advertising relies upon human interaction and response to answer telephones, interview prospective clients, and then (1) send such prospective clients information and material by traditional mail (incurring additional costs), and wait for return of such materials by completed mail (incurring additional costs), and/or (2) arrange a later meeting at some physical location such as the customer's home or the lawyer's office for the purpose of interview and completion of materials and execution of an engagement agreement, the Business Method eliminates these steps, costs and intervening time periods by use of a questionnaire designed specifically for use in determining whether a potential customer has a viable legal claim.

The questionnaire is provided electronically to consumers/visitors immediately at the time of their initial visit to the website, and captures key information about the consumer, their product use and their claims, including their name, address, telephone number and contact information, product information (name of product and date of purchase or use), and claim information (whether the person has been injured, consulted a doctor and other questions) and the consumer is provided three options to determinate questions (yes, no, not sure). Based on the information provided, an analysis is performed as to whether the information presented by the consumer meets the criteria of the operator for acceptance of the case, which is performed manually or may be automated electronically. In the case where the responses indicate that a claim is not present, the Business Method may automatically notify and reject the claim of the visitor, providing immediate notification of rejection, which typically requires a secretary or the lawyer to write a letter and post via US mail, or other delivery service, advising of the rejection of the claim and of the applicable statue of limitations governing the consumer's claim. The procedures and automated methods of this invention greatly reduce time, resources and cost needed to analyze claims, accept claims and reject claims. It should be noted that significant resources (time, correspondence, employee, postage and delivery costs) are often committed to rejecting claims and the Business Method electronically calculates these outlays of time, resources and costs, provides for timely and efficient service, while also creating an electronic record of rejection which will reduce the prospect and associated cost of malpractice claims, which may account for a significant portion of the lawyer's time and costs.

This Business Method is the fastest, most comprehensive and broadest penetration into the national market in a time sensitive business, triggered by the event of a product recall, warning or alert, or other announcement concerning product safety.

This method greatly increases the timely presentation of advertising, as the Business Method is not reliant on newspaper editing or printing, and not reliant on expensive production and placement of television or radio programming, making the fastest penetration into the marketplace, and providing the consumer with the most immediate and comprehensive information and service, which is especially important in the event of a product recall, which creates a “time is of the essence” situation, with an accompanying and immediate spike in the interest of consumers in seeking product and claim information, and in the ultimate engagement of a lawyer to preserve and present the claims.

The Business Method of this invention electronically and automatically matches a consumer with a lawyer in a specific geographic region, specialized in product liability claims involving a specific product. In the event of an inquiry which meets the criteria for an acceptable claim, the geographic information provided by the consumer will fall into a specific geographic region. The operator may electronically and automatically redirect the inquiry meeting such “acceptance criteria” to a lawyer in the specific geographic region of the inquiry, providing such lawyer with the name, address, and contact information for the customer/client, along with information concerning the product used, injury and medical status of the client/consumer. Again, this directing feature removes the need or a person to deliver such new client/consumer information by telephone, fax, letter or other slower delivery method and increases critical response time in terms of making a connection between the regional lawyer and the consumer/client.

In addition to the features above, this Business Method provides a far superior accounting, communication and tracking method, allowing the use of the information received to create an automated database of clients and customers accepted and rejected with regard to specific products. The automatic database is superior to a manual database as it is immediate, easy to edit or segment, may be digitally separated for various purposes, uses and cataloguing, and removes human error and oversight. The aspect of human error and oversight is particularly important in the legal business where legal malpractice insurance is less expensive for lawyers operating an electronic database, and the maintenance of an automated and electronic database may help to reduce malpractice claims by customers or claimants alleging oversight or human error, which accounts for a significant portion of marketplace claims in the product liability field.

Electronic notification or re-notification to consumers in the database may be accomplished when scientific medical or legal developments, or product, government or manufacturer announcements take place. In addition to the above, the automated database by product, allows the operator to store information which may be used for many purposes, including notification or re-notification of subsequent news concerning product safety involving the particular product for which the consumer originally inquired. In other words, a consumer may inquire in year one about a specific product and have no claim or cognizable injury at that time. In year three, a medical study may disclose that the specific product, for which the consumer earlier inquired, may result in a newly discovered disease or injury. The operator of the business method may communicate with consumers and notify them of the study and the consumers may thereafter determine through medical evaluation, or other procedure, that they indeed suffer from the newly discovered disease or symptoms associated with the product In such case, the operator could later accept the claim of the consumer, who was electronically contacted based on the original prior inquiry and retrieval from the database.

This Business Method also creates a delivery and notification system and service that may be used alone or may be merged with other databases, to deliver claim information on a national basis. The database also creates a clearing house for specific groups of consumers having been injured by a specific product. For example, for all persons presenting clams in connection with a specific product, news and updates and forms that are typically generated in product liability litigation may be mass transmitted electronically increasing the speed of deliver of such information, documents and items, removing chance of poor delivery of documents (loss or untimely delivery by postal carrier) which may impact maintenance of claims. It also removes the high cost of sending voluminous documents to large numbers of consumers on a repeated basis. Again, this mode of communication preserves the specific time and date of the communication of the information to the consumer, reducing uncertainty and potential cost related to proving timely service with reference to potential malpractice claims. This delivery and notification service may be used by lawyer groups, nationally coordinated product liability claims, and offices or groups dedicated to, or responsible for, administering product liability claims concerning a specific product. Consumer, claim and legal information may be merged with other databases, or may serve as the central repository for all information (for (1) collection, and (2) broadcast to all product users).

The present invention provides a new and unique Business Method to provide automated daily health information including product safety announcements and government recalls, product and health updates, all collected through automation, as described above, and achieved electronically through leading media sources and linking relationships with leading health information providers, and through electronic notification from all US government agencies responsible for, and empowered to, recall consumer products, including those deemed defective and dangerous.

The most significant product and drug recalls are selected by matrixing the number of users known to have purchased or used the product or drug, against the severity of the potential danger of injury to the consumer, as valued by the government assessment of the risk, which is correlated by government attachment to the danger of recall level (for example, FDA Level I, II, or III recall). The most significant recalls in terms of consumer numbers and assessment of danger or injury (highest consumer impact yield) will be featured on a website for worldwide consumer access and consumption. With regard to a recalled product or drug, the consumer may obtain the recall information, daily updated news, may access daily update doctor-produced health information, and may contact legal counsel in the region or state where the consumer lives, to determine relevant laws governing their ability to participate in any local or national claims presentation or administration established or funded by the manufacturer and/or government. In cases of national litigation and claims administration, official websites have been, or will be, established and these will be featured and links provided for the consumer. The invention will coordinate and categorize all of the news, health, government, manufacturer, legal and claim information in one resource body, resulting in the consumer obtaining timely and comprehensive information and resources, with the ability for the consumer to provide electronically the name of the recalled or faulty product of their inquiry, along with specific information about their particular problems, which will be electronically transmitted to a legal specialist in the area of product liability in their region or state, which will be reviewed to determine the viability of a legal claim on behalf of the consumer.

The instant invention will be the first national resource and method for consumers, impacted by recalled or faulty products, to obtain, in one location, the vast breadth of information and resources available, to electronically obtain government and manufacturers information and/or notices about recalled or faulty products, to obtain doctor produced information and views about products, diseases and conditions, and to have particular problems or injuries reviewed by experienced counsel specialized in the area of product liability lawsuits and to access information and registration forms in the case of the establishment of a national claims office related to specific product recalls and settlements.

No other Internet resource exists that links the consumer to government, health organizations, claims offices, manufacturer information and specialized lawyers, by both product and by specific geographic region.

### OBJECTS OF THE INVENTION

Accordingly, several objects and advantages of the invention are as follows:

It is an object of the present invention to provide a Business Method utilizing a comprehensive web site that provides information on recalled, withdrawn and faulty products and drugs, provides hyperlinks to health and government resources, health organizations, claims offices, manufacturers, and specialized legal counsel based upon the consumer's geographical area.

It is a further object of the invention to provide a method of electronically obtaining consumer information and reviewing consumer claims to determine whether to accept or reject employment.

Yet a further object of the invention is to reach the greatest number of users of a recalled, withdrawn or faulty product in the shortest amount of time, for purposes of having them retain specific attorneys for representation and/or employment.

These and other objects will be shown by reference to the following drawing and description.

### BRIEF DESCRIPTION OF THE DRAWINGS

FIG. 1 is a block diagram showing the recalled product Business Method and information system according to the present invention.

### DETAILED DESCRIPTION OF THE INVENTION

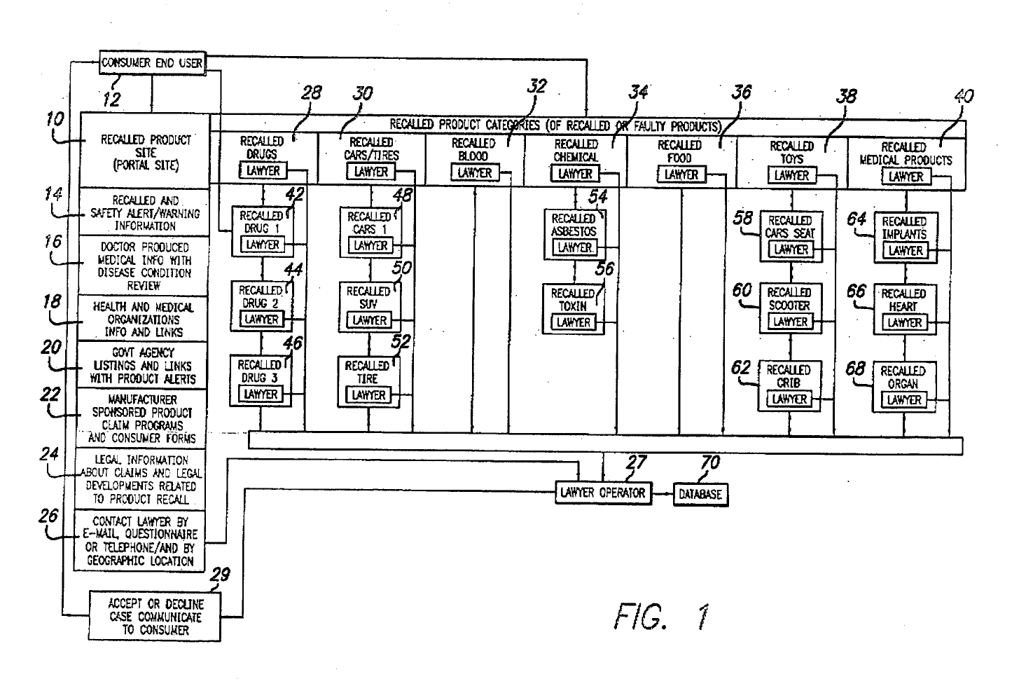

Referring now to the drawings, there is shown in FIG. 1 the Business Method of this invention in which there is a web site 10, which may entitled “Recalled Product” or some variation thereof. The consumer 12 reaches the site by going directly to the site 10, if the consumer knows the Uniform Record Locator (URL) address or by entering “recalled product” as a search in any search engine.

When the consumer 12 reaches the site 10, he or she sees a plurality of portals 14, 16, 18, 20, 22, 24 and 26 on which the consumer 12 may “click” to reach the identified information. These information portals are links to other sites and/or resources where the consumer can obtain a large volume of information about the recalled, withdrawn or faulty product in which he or she is interested.

These information portals include a recalled and safety alert/warning information portal 14 which is a link to sites which provide this information; a doctor produced medical information portal 16 which addresses diseases and conditions, recalled products, health recommendations and links to other medical sites; a health and medical organization portal 18 which provides disease and condition specific information and links to government resources, non-profit and other health and medical organizations and information; a govermnment agency listing portal 20 with links to relevant government agencies responsible for product safety and product recalls; a manufacturer sponsored product claim program portal 22 providing consumer information and claim/registration forms, a legal information portal 24, which provides information and/or links to sites which give legal information about recalled or faulty products; and a portal 26 to immediately contact a lawyer (law firm) by e-mail, questionnaire, or telephone. The lawyer contacted will be in the geographical area of the consumer.

The consumer 12 will be urged to complete a questionnaire in which he or she will enter their name, address, phone number, email address, the name of the recalled or faulty product, whether the consumer has suffered injury and whether the consumer has received medical treatment. If the consumer answers “no” to the last two questions, that is, no injury, no treatment, the claim, if desired, can be automatically and electronically rejected, so that no wasted time is spent by the operator/lawyer (law firm), or his staff, with that consumer. The consumer will also be notified of the applicable statute of limitations, providing a public service and protecting against legal malpractice claims.

The consumer's information, however, will be sent to a database 70 and kept in the event further events take place which might warrant contacting formerly rejected consumers to advise them of further information, to check to see if they have now suffered injuries and had medical treatment or for any other reasons, including engagement of the lawyer (law firm).

Portals 14 through 26 are representative only, as other portals can be added for specific purposes if desired.

Site 10 will also have a series of portals dedicated to specific recalled product catagories or areas including, recalled drugs 28; recalled cars/tires 30; recalled blood 32; recalled chemicals 34; recalled food 36; recalled toys 38; and recalled medical products 40. Other specific portal catagories or areas can be added, when any new recalled products are announced. “Recalled” here also means withdrawn products or products on which warnings have been issued, at the option of the operator of the site.

If the consumer clicks on any of these recalled product portals or catagories, he or she is sent to a site specifically devoted to that class of recalled or faulty products. Within that site there may be more than one product and the consumer can then click on the specific product in that catagory of his or her interest. This is shown as recalled drug 1 (42); recalled drug 2 (44); and recalled drug 3 (46). Under recalled cars/tires 30 there are recalled car 1 (48), recalled SUV (50) and recalled tires (52). Each of these sites will have specific information about a specific recalled or faulty product, such as Firestone tires. Also, each of these sites will have an icon which will take the consumer directly o the same lawyer contact screen 27 that occurred when the consumer clicked on the lawyer portal 26.

These portal catagories and the specific product sites each have their own URL addresses so that the information may be listed on search engines or other listing or published resources, so that the consumer may go directly to those sites through entering the catagory or product specific URL address or through any search engine, by searching the specific product name combined with the word “recalled”. This provides another means for the consumer to quickly find the information he or she desires, with reference to a specific product, along with a specialized product liability attorney, which increases market penetration and traffic to this web site.

Under recalled chemicals 34 there is shown sites for recalled asbestos 54 and recalled toxin 56. Under recalled toys there is shown recalled car seat 58; recalled scooter 60 and recalled crib 62. Sites may be closed if the recalled product cases are all closed or for any other reason. Under recalled medical products is shown recalled implant 64, recalled heart valve 66 and recalled organ 68.

These sites are all shown by example only. Other sites will be added if additional recalls or warnings occur. In use each site will be related to a specific recalled product. A site may also be created for a product warning or other negative report short of a recall. As seen, each of these sites has an icon for direct contact to obtain a lawyer (law firm) 27, giving the consumer the option to go to site 27, to obtain a lawyer (law firm), from the home page 10 or 26, from any of the general product sites or catagories 28-40 and any of the specific sites 42-68.

Once the consumer has reached site 27, he or she may send an e-mail or preferably fill out the questionnaire, which is sent to the Lawyer/Operator site 27. The case may be accepted or declined 29, either automatically or after review by the lawyer's staff or by the operator of the site 10. If the case is declined, automatically as set forth above, or after review by legal staff or the operator, the rejection is sent back to the consumer. If the case is accepted, or if the lawyer wants more information, contact is made by the lawyer, or his staff, with the consumer.

As set forth above, this Business Method is available to the consumer 24 hours per day, 7 days per week, 365 days per year. It may be modified and updated very quickly if notices, warnings or reports are issued by the government, a manufacturer, or other groups, if medical or scientific findings or reports are determined or announced or if the facts change or additional information is otherwise made available. The invention gives a one-stop location for consumers to get comprehensive information and resources on all recalled, withdrawn or faulty products or products on which warnings have been issued. The invention provides direct access to government agencies and resources, health organizations, manufacturers, health and/or medical sites, claims programs, and sites specifically created for specific recalled or faulty products. Most importantly, it provides direct speedy access to critical information concerning recalled or dangerous products and immediate access to lawyers (law firms) who are experienced in the field of recalled or faulty products.

Having thus described the invention,

I claim:

1. A method to obtain consumer inquiries and resulting employment from consumers who have been injured by dangerous or defective products comprising, creating an Internet web site specifically for dangerous or defective products, said site comprising links to govenment agencies, health organizations, manufacturers, medical sites and product liability attorneys, creating specific sub-sites for each catagory of dangerous or defective product, creating second sub-sites in each catagory for each dangerous or defective product in said catagory, each said web site, link and sub-site having a link to contact an attorney electronically.

2. The method of claim 1 further comprising means for the consumer to contact an attorney by e-mail or by completing a questionnaire.

3. The method of claim 2 in which the questionnaire requires the consumer to provide his name, address and phone number, a description of the dangerous or defective product, whether the consumer has been injured by the product and whether the consumer has had medical treatment.

4. The method of claim 3 in which a completed questionnaire is electronically sent to an attorney in the geographical area of the consumer's address.

5. The method of claim 4 in which the consumer questionnaire is automatically electronically rejected if the consumer indicates in the questionnaire that he has not been injured and has not had medical treatment.

6. The method of claim 3 in which the completed questionnaire is also stored in a database.

7. A method for attorneys, who engage in handling product liability cases, to obtain employment from consumers who have been injured by recalled or faulty products comprising, creating an Internet web site specifically for said products, said site comprising links to govenment agencies which deal with said products, manufacturers who manufacture said products, medical organizations and providers who deal with said products and a link to said attorneys, creating specific sub-sites for each catagory of products and second sub-sites for each said product within each catagory, each said web site, link and sub-site having a link to contact an attorney who specializes in said cases, means for the consumer to contact an attorney electronically.

8. The method of claim 7 further comprising means for the consumer to contact an attorney by e-mail or by completing a questionnaire.

9. The method of claim 8 in which the questionnaire requires the consumer to provide his name, address and phone number, a description of the dangerous or defective product, whether the consumer has been injured by the product and whether the consumer has had medical treatment.

10. The method of claim 9 in which a completed questionnaire is electronically sent to an attorney in the geographical area of the consumer's address.

11. The method of claim 10 in which the consumer questionnaire is automatically electronically rejected if the consumer indicates in the questionnaire that he has not been injured and has not had medical treatment.

12. The method of claim 9 in which the completed questionnaire is also sent to a database.

13. A method for attorneys, who engage in handling cases involving recalled products, to obtain cases from consumers who have been injured by said recalled products comprising, creating an Internet web site specifically for recalled products, said site comprising links to govenment agencies which deal with said products, manufacturers who manufacture said products, medical organizations who deal with said products and attorneys who specialize in recalled product cases, creating specific sub-sites for each catagory of recalled product, creating second sub-sites for each specific recalled product within each catagory, each said web site, link and sub-site having a link for the consumer to electronically contact an attorney in the consumer's geographical area who specializes in recalled products cases.

14. The method of claim 13 in which a plurality of attorneys are provided, each attorney or firm located in a different geographical area of the United States, in which the consumer contact is sent to the attorney located closest to the consumer.

15. The method of claim 13 further comprising means for the consumer to contact an attorney by e-mail or by completing a questionnaire.

16. The method of claim 14 in which the questionnaire requires the consumer to provide his name, address and phone number, a description of the defective product, whether the consumer has been injured by the product and whether the consumer has had medical treatment.

17. The method of claim 16 in which the consumer questionnaire is automatically electronically rejected if the consumer indicates in the questionnaire that he has not been injured and has not had medical treatment.

18. The method of claim 16 in which the completed questionnaire is also sent to a database.

19. The method of claims 1, 7 or 13 in which each catagory sub-site and each specific product sub-site has its own uniform record locator address.

20. An Internet portal dealing with dangerous or defective products comprising a plurality of first sub-portals, each sub-portal containing dangerous or defective product information and links to government resources and agencies, manufacturers, health and medical organizations and product liability attorneys, a plurality of second sub-portals for each catagory of dangerous or defective products, a plurality of third sub-portals, each third sub-portal containing information on a specific dangerous or defective product within a second sub-portal catagory.

21. The portal of claim 20 in which each second sub-portal and each third sub-portal has a link to contact a product liability attorney.

22. The portal of claim 20 in which each second sub-portal nd each third sub-portal has its own uniform record locator address.

23. The portal of claim 22 in which each said uniform record locator address is a combination of the word “recalled” and the name of the specific dangerous or defective product.

24. The portal of claim 20 further comprising means for the consumer to contact an attorney by e-mail or by completing a questionnaire.

25. The portal of claim 24 in which the questionnaire requires the consumer to provide his name, address and phone number, a description of the dangerous or defective product, whether the consumer has been injured by the product and whether the consumer has had medical treatment.

26. The portal of claim 25 in which a completed questionnaire is electronically sent to an attorney in the geographical area of the consumer's address.

27. The portal of claim 26 in which the consumer questionnaire is automatically electronically rejected if the consumer indicates in the questionnaire that he has not been injured and has not had medical treatment.

28. The portal of claim 25 in which the completed questionnaire is also stored in a database.
